(19) United States
(12) Patent Application Publication
(10) Pub. No.: US 2010/0077591 A1
(43) Pub. Date: Apr. 1, 2010

(54) CRUSHER TOOTH REMOVAL TOOL

(75) Inventors: YOGESH SANVALIYA, Fort McMurray (CA); GARY KEAYS, Fort McMurray (CA)

Correspondence Address: BENNETT JONES LLP;C/O MS ROSEANN CALDWELL, 4500 BANKERS HALL EAST, 855 - 2ND STREET, SW, CALGARY, AB, T2P 4K7, CA

(73) Assignee: SYNCRUDE CANADA LTD. in trust for the owners of the Syncrude Project, Fort McMurray (CA)

(21) Appl. No.: 12/567,420

(22) Filed: Sep. 25, 2009

Related U.S. Application Data
(60) Provisional application No. 61/100,366, filed on Sep. 26, 2008.

(51) Int. Cl. B23P 19/04

(52) U.S. Cl. 29/426.5; 29/700

(57) ABSTRACT

A crusher tooth removal tool is provided having a guide comprising a pair of substantially parallel elongate guide members, said guide having a first end and a second end; a first wedge assembly attached at or near the first end of the guide, said first wedge assembly having a first wedge; a second wedge assembly having a second wedge, said second wedge assembly slideably attached to the guide so that the second wedge and the first wedge are facing each other; a brace fixedly attached at or near the second end of the guide; and a force exerting device connected between the second wedge assembly and the brace such that the force exerting device is operative to force the second wedge assembly along the guide towards the first wedge assembly.

This application claims priority to U.S. provisional patent application No. 61/100,366, filed Sep. 26, 2008.

### FIELD OF INVENTION

The present invention relates to an apparatus and method for the removal of crusher teeth used in a crusher.

### BACKGROUND OF THE INVENTION

Oil sand is a type of bitumen deposit typically containing sand, water and very viscous oil (the bitumen). One method of extracting oil sand from an oil sands deposit, when the oil sand deposit is located relatively close below the ground surface, is through mining. This method entails excavating down through the ground surface to where the oil sand deposit occurs and removing oil sand from the deposit with heavy machinery. Typically, this removal of the oil sand from the deposit is done with some of the largest power shovels and dump trucks in the world, with the power shovels removing shovel-loads of oil sand from the deposit and loading the collected oil sand onto dump trucks to be carried away for further processing.

The viscous bitumen tends to hold the sand and water together causing the mined oil sand to contain lumps and chunks, some of which can be quite large. Because of the size of some of these pieces of mined oil sand, the mined oil sand is typically transported by the dump trucks to a crusher plant, which breaks the mined oil sand into suitably sized pieces for further processing in order to extract the oil.

The crusher plants are used to reduce the size of the lumps and chunks of mined oil sand to a suitable size for further processing. Typically, the crusher plant has a hopper where dump trucks empty their load of mined oil sand. From the hopper, the oil sand is fed into the crusher mechanism, such as a double roll crusher, located below the hopper. In a double roll crusher, a pair of counter-rotating crusher rolls are spaced a set distance apart to make oil sand small enough for further processing. The small pieces fall through the spaces between the pair of counter-rotating rolls and are carried off to the next stage in the process. For pieces of the mined oil sand that are too large to pass between the pair of counter-rotating crusher rolls, these pieces are instead broken up by the crusher rolls until they are small enough to pass through the space between the counter-rotating crusher rolls.

Each crusher roll has a number of removable crusher roll segments bolted to the shell of the roll and each crusher roll segment has a number of replaceable crusher teeth mounted on the roll segment. In this manner, when the crusher roll segments are bolted to the pair of crusher rolls, the crusher teeth mounted in the roll segments on one of the crusher rolls mesh with the crusher teeth on the other crusher roll, helping to break down the pieces of mined oil sand and preventing long narrow pieces of mined oil sand from passing through the crusher. Because the pair of crusher rolls are spaced a set distance apart to only allow pieces of mined oil sand with a certain width to pass through the pair of crusher rolls, without the crusher teeth, long narrow pieces of mined oil sand, that are too large for the next stage of processing, might pass between the pair of crusher rolls.

Each of these crusher teeth are typically conical in shape and are made to be replaceable. Because significant force and abrasion is seen by the crusher teeth during the operation of the crusher, the teeth wear down over time, requiring them to be periodically removed from the roll segment and replaced with new teeth.

The crusher teeth typically have an integral shaft below the conical head used for crushing and are installed in place on the crusher roll segment by sliding the shaft of the crusher tooth into a corresponding passage of a tooth holder on the crusher roll segment. Typically, a threaded pin passes through the tooth holder and extends into a recess in the shaft of crusher tooth, to hold the crusher tooth in place.

To remove a tooth from a crusher roll segment, the pin is removed from the recess in the shaft of the crusher tooth and then the shaft of the tooth has to be withdrawn from the passage of the tooth holder of the crusher roll segment. Because of the fine oil sand entrapment between the shaft of the tooth and the tooth holder clearances and the forces that have acted on the crusher teeth during the operation of the crusher, these crusher teeth can be quite strongly jammed into the tooth holder in the crusher roll segment. Previously, the worn out crusher teeth were removed from the crusher roll segment using a pneumatic jack hammer. A person operating the jack hammer would insert the hammer tip, as best as he or she could, between the head of a tooth to be removed and the tooth holder. The operator then used the jack hammer to try and force the head of the tooth upwards and away from the roll segment by driving the hammer tip between the tooth and the roll segment, causing the shaft of the tooth to be drawn out of the passage in the tooth holder.

This previous method has a number of disadvantages. Using a pneumatic jack hammer to remove the teeth can create safety problems because the force of the impacting hammer tool tip on the tooth and/or tooth holder can send chips, broken off of the tooth, the tool tip and/or the tooth holder, flying. The handling weight and associated vibration of the pneumatic hammer can create other problems for tool operators. Additionally, removing the crusher tooth in this manner is relatively time consuming. It also requires some exertion and skill on the part of the operator to keep the impacting hammer tip hitting the tooth and tooth holder more or less at the join between the two.

It will therefore be appreciated that there exists a need for a method and apparatus for safely and relatively quickly removing a crusher tooth.

### SUMMARY OF THE INVENTION

In an aspect, a crusher tooth removal tool is provided. The removal tool has a guide comprising a pair of substantially parallel guide members. In one embodiment, first wedge assembly is attached at one end to the guide members in such a manner that it will not move relative to the guide members. A second wedge assembly is attached to the guide members such that it will slide along the guide members. A hydraulic cylinder or other force exerting device is connected between the second wedge assembly and a brace fixed to the guide members. The first wedge assembly and the second wedge assembly have a first wedge and a second wedge, with the first wedge and second wedge positioned to face one another. By pressurizing the hydraulic cylinder and exerting a force between the brace and the second wedge assembly, the second wedge assembly can be driven along the guide members causing the second wedge to move towards the first wedge.

In another embodiment, both wedge assemblies are slideably attached to the guide and at least two braces and hydraulic cylinders can be used to move the two wedges towards one another.

In another aspect, to use the removal tool, the removal tool is place around a crusher tooth to be removed with the first wedge and second wedge positioned on either side of the crusher tooth. The removal tool is positioned so that the tip of either the first wedge or the second wedge is placed at the join between the head of the crusher tooth and the tooth holder the crusher tooth is mounted in. With the removal tool in place, the hydraulic cylinder is pressurized which applies a force to the second wedge assembly moving the second wedge assembly towards the first wedge assembly. By exerting enough force with the hydraulic cylinder, the first wedge and second wedge are driven between the head of the tooth and the tooth holder. As the hydraulic cylinder continues to apply a force to the second wedge assembly, the first wedge and second wedge are driven farther between the head of the tooth and the tooth holder, with the increasing height of the first wedge and second wedge forcing the head of the tooth away from the tooth holder and withdrawing the shaft of the tooth from the tooth holder.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a perspective view of a crusher tooth removal tool;

FIG. 2 is a top view of the crusher tooth removal tool shown in FIG. 1;

FIG. 3 is a side sectional view of the crusher tooth removal tool shown along line AA′ of FIG. 2;

FIG. 4 is a perspective view of a crusher roll segment containing a number of removable teeth;

FIG. 5 is a front view of a tooth;

FIG. 6 is a bottom view of the tooth illustrated in FIG. 5; and

FIG. 7 is a perspective view of a tooth holder.

### DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

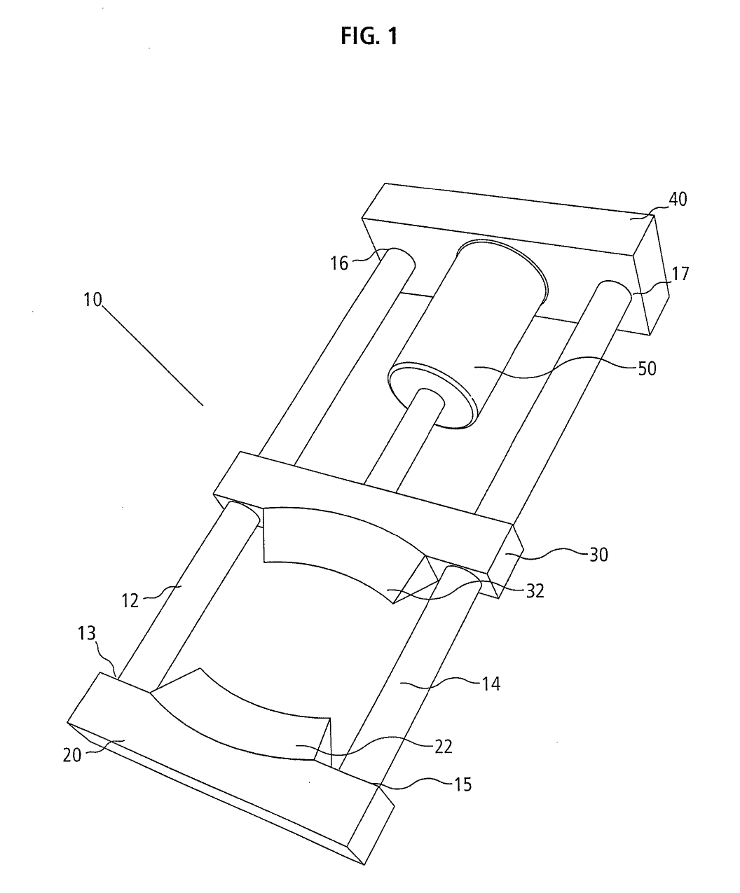

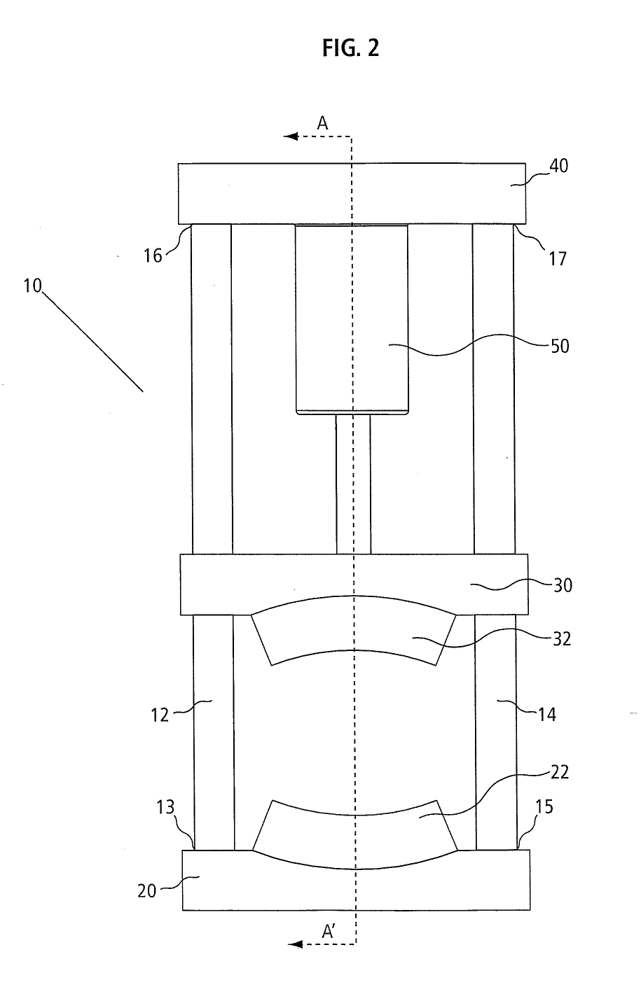

FIGS. 1 and 2 illustrate a crusher tooth removal tool 10. The crusher tooth removal tool 10 uses a double wedge action to remove a crusher tooth from a crusher roll segment. A pair of substantially parallel guide members 12, 14 are provided with a first wedge assembly 20 attached to first ends 13, 15 of the guide members 12, 14, respectively, so that the first wedge assembly 20 will not move relative to the guide members 12, 14. The wedge assembly 20 has a first wedge 22. A second wedge assembly 30, having a second wedge 32, is slideably attached to the guide members 12, 14 so that the second wedge assembly 30 can slide along the guide members 12, 14. The first wedge assembly 20 and the second wedge assembly 30 are positioned so that the first wedge 22 faces the second wedge 32 and vice versa.

In an aspect, the first wedge 22 and second wedge 32 are semicircular in shape. Ideally, the radius of curvature of the first wedge 22 and the second wedge 32 will substantially match the radius of curvature of an outside surface of a typical bottom of a cone-shaped crusher tooth.

A brace 40 is provided on second ends 16, 17 of the guide members 12, 14, respectively, and the brace 40 is attached to the guide members 12, 14 so that the brace 40 will not slide relative to the guide members 12, 14.

A hydraulic cylinder 50 is provided between the brace 40 and the second wedge assembly 30. Because the brace 40 is fixed relative to the guide members 12, 14, pressuring the hydraulic cylinder 50 causes the hydraulic cylinder 50 to slide the second wedge assembly along the guide members 12, 14 towards the first wedge assembly 20. Typically, the hydraulic cylinder 50 is pressurized with a hand pump (not shown), although various other pressure devices could be used to pressurize the hydraulic cylinder 50.

In a further aspect, the hydraulic cylinder 50 could be replaced with another force exerting device, such as a pneumatic cylinder, pneumatic jack, screw jack, hydraulic jack, etc. It is understood that more than one force exerting device could be used, for example, a first force exerting device to operate a first wedge assembly comprising a first slideable wedge and a second force exerting device to operate a second wedge assembly comprising a second slideable wedge.

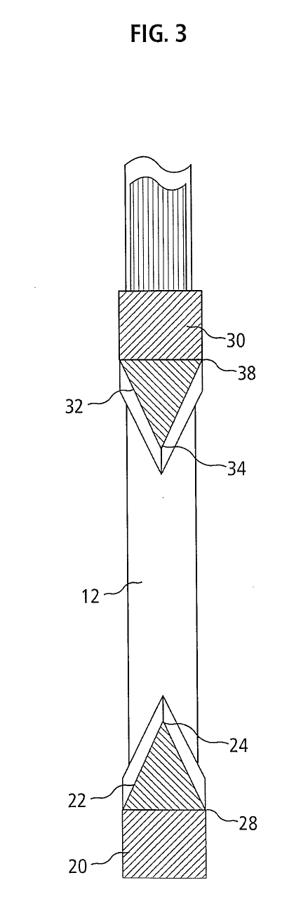

FIG. 3 illustrates a side sectional view of the crusher tooth removal tool 10, along sectional line AA′ shown in FIG. 2, showing the side profiles of the first wedge 22 and the second wedge 32. The first wedge 22 has a narrow tip 24 and increases in height along a length of the first wedge 22 from the tip 24 towards a back end 28 of the first wedge 22. Similarly, the second wedge 32 also has a narrow tip 34 and increases in height along a length of the second wedge 32 from the tip 34 towards a back end 38 of the second wedge 32.

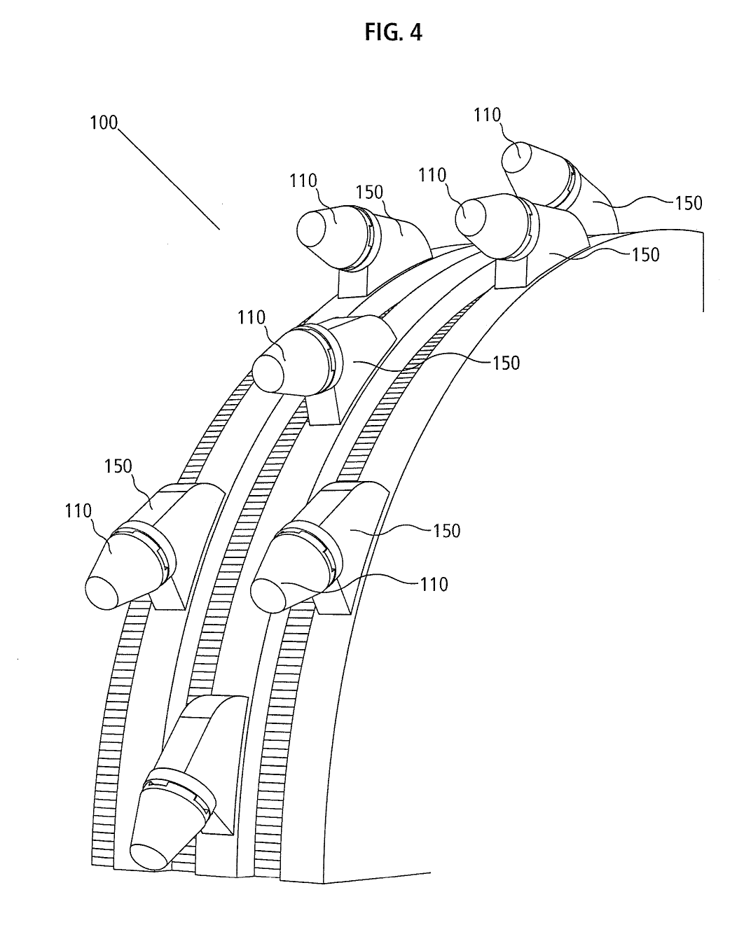

FIG. 4 illustrates a crusher roll segment 100, as is known in the art. The crusher roll segment 100 is attached to the outside surface of a crusher roll (not shown) and has a plurality of removable crusher teeth 110, with each tooth 110 mounted in a tooth holder 150.

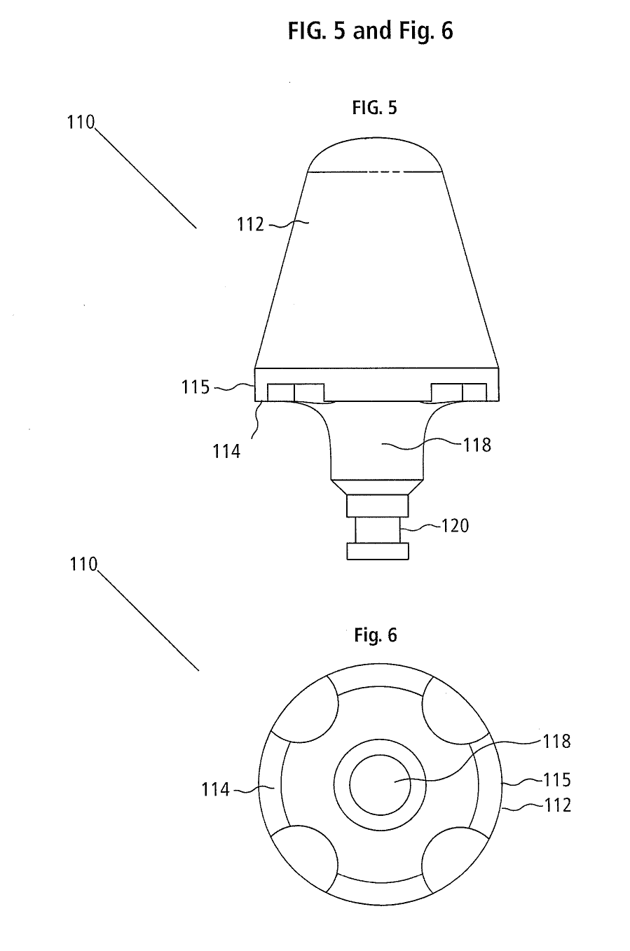

FIGS. 5 and 6 illustrate a removable crusher tooth 110, as is known in the prior art. The tooth 110 has a head 112 and a shaft 118. The head 112 is the portion of the tooth 110 that comes into contact with the oil sand to be crushed and the shaft 118 is used to mount the tooth 110 in a tooth holder 150. A base 115 of the head 112 of the tooth 110 is wider than the shaft 118, defining an annular-shaped bottom face 114. A recess 120 is provided in the shaft 118 to receive a securing pin (not shown) when the tooth 110 is installed in place in a tooth holder 150.

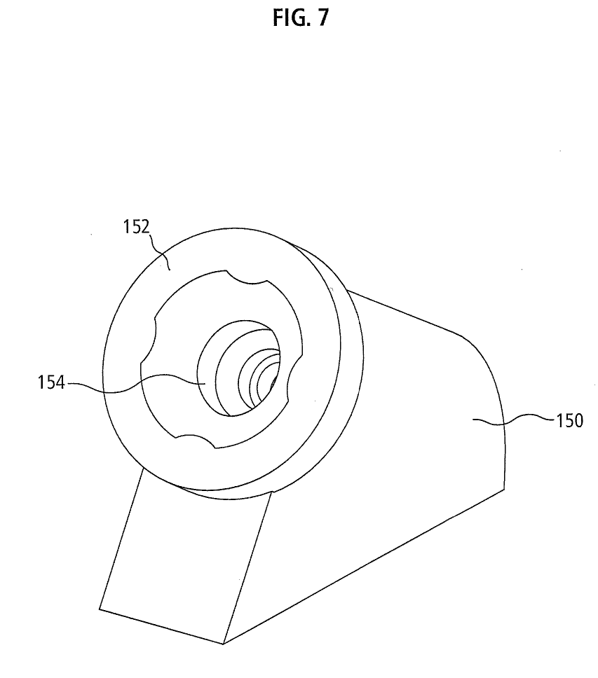

FIG. 7 illustrates a tooth holder 150. Tooth holder 150 has an annular-shaped top surface 152 surrounding an aperture 154. Referring to FIGS. 4-7, the aperture 154 in the tooth holder 150 is sized to fit the shaft 118 of the tooth 110. When the shaft 118 of the tooth 110 is fully inserted into the aperture 154, the bottom face 114 of the head 112 of the tooth 110 lies against the top surface 152 of the tooth holder 150. When a downward force is applied to the tooth 110, the top surface 152 of the tooth holder 150 supports the tooth 110 in place.

Referring to FIGS. 1-7, to remove a tooth 110 from a tooth holder 150 on the crusher roll segment 100, using the crusher tooth removal tool 10, the crusher tooth removal tool 10 is positioned so that the first wedge assembly 20 and second wedge assembly 30 are spaced far enough apart so that the crusher tooth removal tool 10 can be placed over the tooth 110.

With the crusher tooth removal tool 10 positioned over the tooth 110 to be removed, the first wedge 22 is placed so that the tip 24 of the first wedge 22 is engaged between the base 115 of the head 112 of the tooth 110 and the tool holder 150. The hydraulic cylinder 50 is then pressurized, moving the second wedge 32 along the guide members 12, 14, towards the first wedge 22, until the second wedge 32 contacts the tooth 110. The tip 34 of the second wedge 32 is then positioned so it contacts the join between the base 115 of the head 112 of the tooth 110 and the top surface 152 of the tool holder 150. Alternatively, the tip 34 of the second wedge 32 can be placed so that the tip 34 is engaged between the base 115 of the head 112 of the tooth 110 and the tool holder 150 and the hydraulic cylinder 50 pressurized to draw the first wedge 22 against the other side of the tooth 110.

With the crusher tooth removal tool 10 placed around the tooth 110 so that the tip 24 of the first wedge 22 and the tip 34 of the second wedge 32 are engaged between the head 112 of the tooth 110 and the tooth holder 150, the hydraulic cylinder 50 is further pressurized, continuing to force the second wedge assembly 30 towards the first wedge assembly 20. As the second wedge assembly 30 is forced towards the first wedge assembly 20, the second wedge 32 and the first wedge 22 are driven between the head 112 of the tooth 110 and the tool holder 150, with the tip 24 of the first wedge 22 and the tip 34 of the second wedge 22 separating the bottom face 114 of the head 112 of the tooth 110 from the top surface 152 of the tool holder 150. As the second wedge 32 continues to be forced towards the first wedge 22 by the hydraulic cylinder 50, the increasing height of the first wedge 22 and the second wedge 32 along their lengths from the tips 24, 34 to the back ends 28, 38, respectively, forces the head 112 of the tooth 110 upwards from the tool holder 150 causing the shaft 118 of the tooth 110 to be extracted from the aperture 154 in the tool holder 150.

With the shaft 118 of the tooth 110 withdrawn or partially withdrawn from the aperture 154 in the tool holder 150, an operator can then remove the tooth 110 from the tooth holder 150, using simple hand tools if necessary.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. A crusher tooth removal tool comprising:
a guide comprising a pair of substantially parallel elongate guide members, said guide having a first end and a second end;
a first wedge assembly attached at or near the first end of the guide, said first wedge assembly having a first wedge;
a second wedge assembly having a second wedge, said second wedge assembly slideably attached to the guide so that the second wedge and the first wedge are facing each other;
a brace fixedly attached at or near the second end of the guide; and
a force exerting device connected between the second wedge assembly and the brace such that the force exerting device is operative to force the second wedge assembly along the guide towards the first wedge assembly.

2. The crusher tooth removal tool of claim 1 wherein the force exerting device is a hydraulic cylinder.

3. The crusher tooth removal tool of claim 1 wherein the first wedge and second wedge are semicircular in shape.

4. The crusher tooth removal tool of claim 1 wherein the first wedge and second wedge have a triangular profile.

5. A method of removing a crusher tooth having a head and a shaft from a tooth holder, the method comprising:
providing a tool having a first wedge and a second wedge;
placing the tool over the crusher tooth such that the first wedge is on a first side of the crusher tooth and the second wedge is on an opposite side of the crusher tooth;
applying a force to at least the second wedge to drive the second wedge towards the first wedge; and
as the second wedge is driven towards the first wedge, inserting the first wedge and the second wedge between the head of the tooth and the tooth holder to force the tooth away from the tooth holder.
